(19) United States
(12) Patent Application Publication
(10) Pub. No.: US 2026/0111937 A1
(43) Pub. Date: Apr. 23, 2026

(54) ADDING SOFTWARE COMPONENT TO COMPUTER PROGRAM

(71) Applicant: Je'Marra Niles, Los Angeles, CA (US)

(72) Inventor: Je'Marra Niles, Los Angeles, CA (US)

(21) Appl. No.: 19/339,140

(22) Filed: Sep. 24, 2025

Related U.S. Application Data
(60) Provisional application No. 63/675,176, filed on Jul. 24, 2024.

(51) Int. Cl. G06Q 30/0601; G06F 9/445; G06Q 10/083; G06Q 10/1093

(52) U.S. Cl. CPC G06Q 30/0601; G06F 9/44526; G06Q 10/083; G06Q 10/1093

(57) ABSTRACT

A downloadable e-commerce software plug-in is disclosed that enables customers to complete a purchase immediately while scheduling shipment of the purchased product for a future date selected by the customer. The system comprises a checkout interface configured to receive purchase requests, a scheduling module with a calendar interface allowing the user to choose one or more shipment dates, a payment processing module configured to process full payment and apply a consumer service fee at checkout separate from the product price, and a merchant dashboard configured to notify merchants of the purchase and batch shipments according to selected dates. The downloadable e-commerce software plug-in integrates with existing e-commerce platforms and provides merchants and customers with a secure, flexible, and seasonless shopping experience distinct from pre-order or layaway systems.

### FIELD OF THE INVENTION

The present disclosure relates to adding a software component to a computer program, and more particularly to adding a computer program providing the option to purchase at least one product, to a software component providing the option to deliver the products at a time later than a time of the purchase of the at least one product.

### RELATED APPLICATIONS

This application claims the benefit of U.S. Provisional Ser. No. 63/675,176, filed 07/24/202, entitled “BLU APP-Ordering Now-Shipping Later,” the entire disclosure of which is hereby incorporated by reference herein.

### BACKGROUND

Some mobile applications can be used to purchase products. These mobile applications display products and their prices to a buyer. The buyer orders the products by providing an address and a payment method. Once the seller receives the order, the seller ships the products to the provided address of the user. The time the products require to reach the user's address is solely determined by the company shipping the products from the seller to the buyer. Neither the buyer nor the seller may influence this time.

Existing systems such as pre-order and layaway do not provide the same functionality as the presently disclosed invention. In a pre-order system, customers reserve products not yet available, with shipment dictated by the merchant. In a layaway system, customers pay in installments, and delivery occurs only after final payment.

In contrast, the present invention enables a customer to purchase a product in full at checkout and select a future shipment date of their choice through a calendar interface. Ownership transfers at the time of purchase, while shipment is deferred until the customer's chosen date. The invention further distinguishes itself by its downloadable e-commerce software plug-in architecture, merchant dashboard with batch management, and consumer service fee model that incentivizes adoption by merchants without upfront cost. These features establish the invention as a technical software solution rather than a financial arrangement.

### SUMMARY

The present disclosure describes various embodiments of a system, comprising a computer medium including executable instructions to add a software component to a computer program, wherein the computer program provides the option to purchase at least one product, and wherein the software component provides the option to deliver the products at a time later than a time of the purchase of the at least one product, and a processor to execute the instructions. The software component includes a downloadable e-commerce software plug-in. The computer program is accessible via a web browser. The computer program includes a mobile application. The software component is added to the computer program, once a payment is received.

The present disclosure also describes various embodiments of a method, comprising: using a computer program to purchase at least one product, using a system, comprising a computer medium including executable instructions, to add a software component to the computer program, wherein the software component provides an option to select a time for delivering the at least one product. The software component includes a downloadable e-commerce software plug-in. A web browser may access the computer program. The computer program may include a mobile application. The software component may be added to the computer program, once a payment is received.

The present disclosure also describes various embodiments of a downloadable e-commerce software plug-in for integration with online stores. In one or more embodiments, the downloadable e-commerce software plug-in is for integration with a mobile application (app) for iOS and/or android devices. The downloadable e-commerce software plug-in comprises a checkout interface configured to receive a purchase request for a product from a user, a scheduling module configured to allow the user to select a future shipment date for the purchased product, a payment processing module configured to process payment from the user at the time of purchase; and a merchant dashboard configured to notify a merchant of the purchase and schedule shipment of the product according to the user-selected future shipment date. The scheduling module includes a calendar interface allowing the user to select one or more available shipping dates. The payment processing module applies a consumer service fee at checkout separate from the merchant's product price. The merchant dashboard is configured to allow batch shipment preparation based on aggregated future shipment dates. The software plug-in integrates with an existing e-commerce platform selected from the group consisting of Shopify, WooCommerce, Magento, and BigCommerce. The scheduling module allows shipment to be delayed for seasonal events, holidays, or sales periods.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a diagram of a system for adding a plug-in to a computer program, comprising a computer medium and a processor, according to one or more embodiments.

FIG. 2 illustrates a flow chart of a method for adding a software component to a computer program, according to one or more embodiments.

FIG. 3 illustrates a BLU system flow diagram, according to one or more embodiments.

FIG. 4 illustrates a BLU process flow that combines merchant and system flow, according to one or more embodiments.

### DETAILED DESCRIPTION

In the following description, reference numbers are used to identify similar elements. Furthermore, the drawings are intended to illustrate major features of exemplary embodiments in a diagrammatic manner. The drawings are not intended to depict every feature of every implementation nor relative dimensions of the depicted elements, and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Also, it is to be understood that the phraseology and terminology used herein is for the purpose of description and should not be regarded as limiting. The use of “including,” “comprising,” or “having” and variations thereof herein is meant to encompass the products listed thereafter and equivalents thereof as well as additional products. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

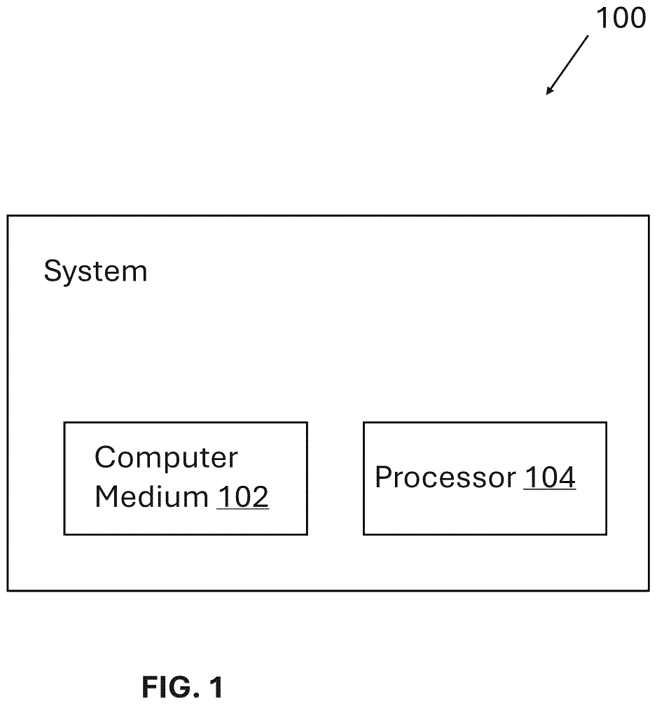

FIG. 1 illustrates a diagram of a system for adding a plug-in to a computer program, comprising a computer medium and a processor. The system 100 includes a computer medium 102 that includes executable instructions to add a software component to a computer program.

The software component may be added to the computer program, once a payment is received.

The computer program in the computer medium 102 provides the option to purchase at least one product. The at least one product may be purchased over the internet, online, or offline. The computer program in the computer medium 102 may purchase products immediately. The computer program in the computer medium 102 may record a time a product is purchased. A user may use the computer program in the computer medium 102. A buyer may use the computer program in the computer medium 102 to buy products. The computer program in the computer medium 102 may be accessible via a web browser. The computer program in the computer medium 102 may be accessible via a mobile application.

The computer medium 102 further includes a software component (e.g., downloadable e-commerce software plug-in and/or add-on). The software component included in the computer medium 102 may provide the option to deliver the products at a time later than a time of the purchase of the at least one product. A user may select a time and/or a date, which is later than a time and/or a date of the user purchasing the products, at which the products are to be delivered. A user may select a time period, counting from a time a user purchases the products, after which the products are to be delivered.

Ther system 100 may also include a processor 104. The processor 104 may execute the instructions stored on the computer medium 102.

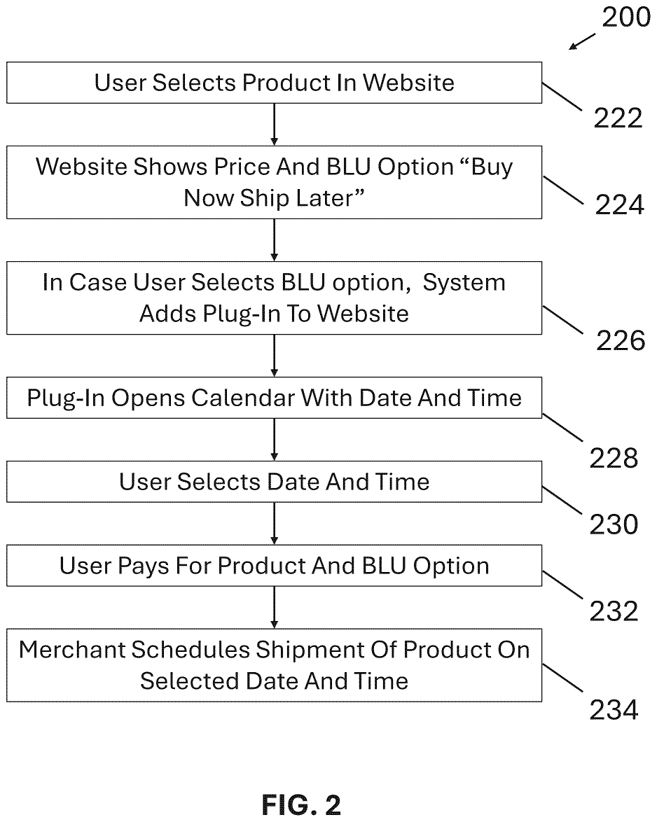

FIG. 2 illustrates a flow chart of a method for adding a software component to a computer program. In a first step 222, a user selects product in a website. In a second step 224, the website shows a price and the BLU option “buy now ship later”. In a third step 226, in case the user selects the BLU option, a system adds a downloadable e-commerce software plug-in to the website. In a fourth step 228, the downloadable e-commerce software plug-in opens a calendar with date and time, In a fifth step 230, the user selects a date and time for the product to be delivered. In a sixth step 232, the user pays for the product and the BLU option. In a seventh step 234, the merchant schedules the shipment of the product on the selected date and time. The software component may include a downloadable e-commerce software plug-in. A web browser may access the computer program. The computer program may include a mobile application. The software component may be added to the computer program, once a payment is received.

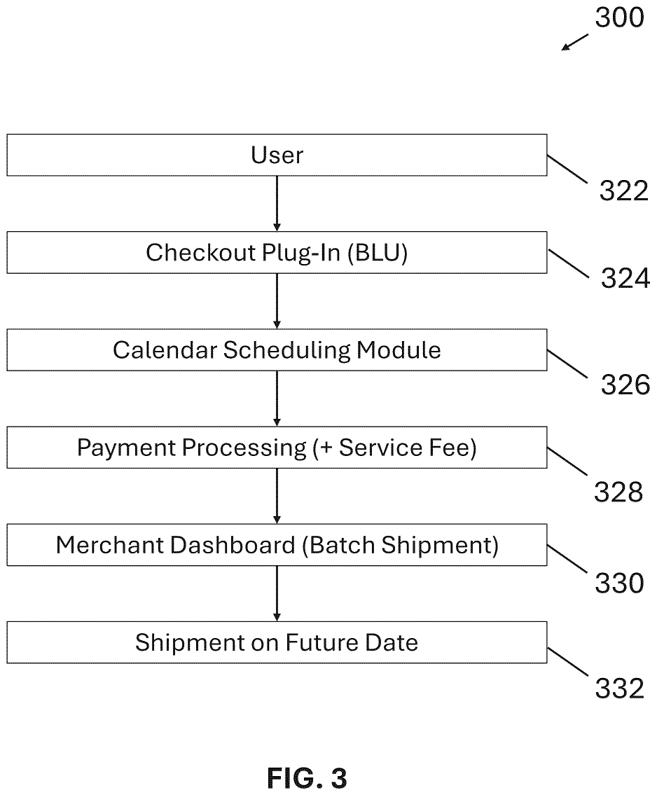

FIG. 3 illustrates a BLU system flow diagram, according to one or more embodiments. A user (step 322) activates the checkout downloadable e-commerce software plug-in (BLU) (step 324). Then, a calendar scheduling module (step 326) opens a calendar for the user to select a date and time for delivering the purchased product. After that, the payment plus a service fee for BLU (step 328) is processed. Then, the merchant receives a message on a dashboard about a batch shipment (step 330). After that, the merchant arranges shipment of the product on a future date (step 332).

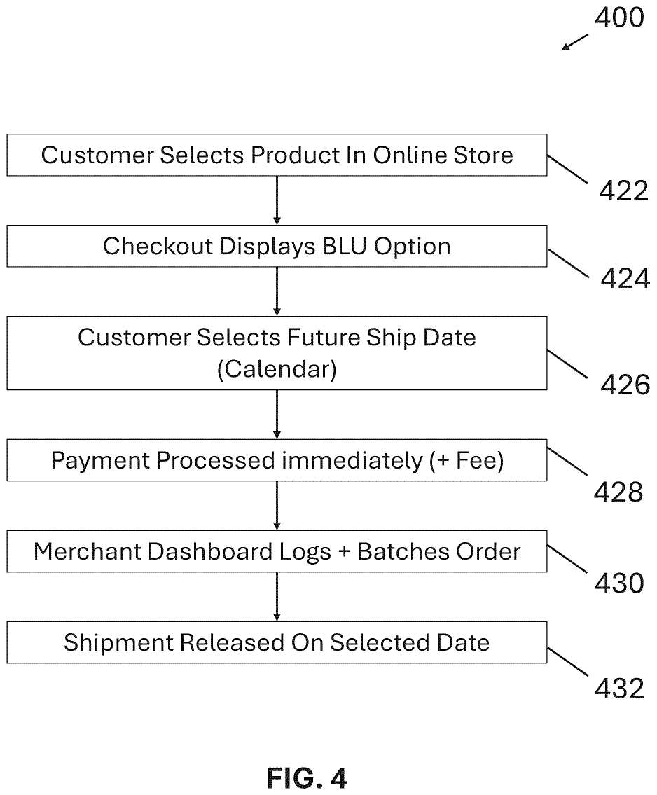

FIG. 4 illustrates a BLU process flow that combines merchant and system flow, according to one or more embodiments. In a first step 422, the customer selects a product in an online store. In a second step 424, a checkout displays the BLU option. In a third step 426, the customer selects a future ship date on a calendar. In a fourth step 428, a payment plus fee made by the customer is processed immediately. In a fifth step 430, the merchant's dashboard logs illustrates batches of orders. In a sixth step 432, the shipment of the product is released on the date selected by the customer.

The software component may be used by online shoppers and online businesses. The software component may be called buy now ship later (BLU) APP or a downloadable e-commerce software plug-in (and, in some embodiments, a mobile application (‘app’) for iOS and Android devices). According to some embodiments presently disclosed, the APP allows customers to purchase a product and have it shipped months or weeks later.

According to some embodiments, the APP comprises a service (subject to a fee) enabling customers to choose a specific shipping date from a calendar. According to some embodiments, the BLU APP may have a user-friendly interface, making it easy for customers to navigate and use the “Buy Now, Ship Later” feature. This will enhance the overall user experience and encourage more customers to use the service (subject to a fee).

According to some embodiments, the APP comprises seamless integration with Shopify as a downloadable e-commerce software plug-in, ensuring wide reach and easy accessibility for both customers and businesses.

According to some embodiments, the BLU APP may include a website/Web APP/plug-in for merchants. The downloadable e-commerce software plug-in may be located on the merchants check out cart for customers to choose a date (e.g., day and/or week of delivery) not an exact day. The customer can't choose an exact day because of holidays, Sundays, and other delivery time constraints.

According to some embodiments, the BLU APP includes a calendar system, wherein the downloadable e-commerce software plug-in may appear as a calendar so that customers may be able to choose the buy now ship later under the BLU link in the merchant's online platform.

According to some embodiments, security may be a priority for the BLU APP service (subject to a fee), with robust measures in place to protect sensitive customer and business data, preventing data breaches and ensuring confidentiality.

The BLU APP may enable customers to pay upfront and have the product shipped on some later date. This may provide online stores with the option to let customers make payments at the time of purchase and receive the product at some later specified date.

According to some embodiments, the BLU APP can be installed on all online stores' checkout pages. This plugin may give customers the option to purchase products in full and select their desired shipping date in advance (e.g., for Christmas or anniversary gifts).

The BLU APP may be integrated with Shopify for the “pay now and ship later” service (subject to a fee), presenting users with a calendar to select the delivery date and showing the cost of using the service (subject to a fee) based on the product's price.

The APP may include a backend web application for order tracking by online store owners and super admins. According to some embodiments, there are different filters for data maintenance on the backend, such as delivery date, delivery status, product cost, and/or customer name.

The APP stipulates that if a customer uses the BLU service on the checkout page of an online portal, an additional fee may be added, which may show the amount the customer may be charged for using the service.

According to some embodiments, customer information, along with product details, may be captured in a database for tracking orders by online store owners and super admins. The plugin's app settings can be used by the merchants to configure the plugin for their portal.

According to some embodiments, there is no need to track order shipping status with any third party. If the delivery date has passed, an assumption is made that the delivery is completed.

According to some embodiments, the BLU APP includes a reminder service for scheduled deliveries, sending notifications to users once the delivery date has passed, and providing a message in the email for customers to contact the online store if they face any issues with receiving their order.

A method using the “buy now ship later” feature includes the following steps. At first a computer program is used to purchase at least one product. Then, a system, comprising a computer medium including executable instructions, is used to add a software component to the computer program. The software component provides an option to select a later time for delivering the at least one product. The software component includes a downloadable e-commerce software plug-in. A web browser accesses the computer program. The computer program includes a mobile application. The method further comprises adding the software component to the computer program, once a payment is received.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

While several illustrative embodiments of the invention have been shown and described, numerous variations and alternative embodiments may occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations may be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . ”

What is claimed is:

1. A system, comprising:
a computer medium including executable instructions to add a software component to a computer program, wherein the computer program provides the option to purchase at least one product, and wherein the software component provides the option to deliver the products at a time later than a time of the purchase of the at least one product, and
a processor to execute the instructions.

2. The system of claim 1, wherein the software component includes a downloadable e-commerce software plug-in.

3. The system of claim 1, wherein the computer program is accessible via a web browser.

4. The system of claim 1, wherein the computer program includes a mobile application.

5. The system of claim 1, wherein the software component is added to the computer program, once a payment is received.

6. A method, comprising:
using a computer program to purchase at least one product;
using a system, comprising a computer medium including executable instructions, to add a software component to the computer program, wherein the software component provides an option to select a time for delivering the at least one product.

7. The method of claim 6, wherein the software component includes a downloadable e-commerce software plug-in.

8. The method of claim 6, wherein a web browser accesses the computer program.

9. The method of claim 6, wherein the computer program includes a mobile application.

10. The method of claim 6, further comprising adding the software component to the computer program, once a payment is received.

11. A downloadable e-commerce software downloadable e-commerce software plug-in comprising:
a checkout interface configured to receive a purchase request for at least one product from a user;
a scheduling module configured to present a calendar interface and allow the user to select a future shipment date for the purchased product;
a payment processing module configured to process payment for the purchased product at the time of purchase and apply a consumer service fee at checkout separate from the product price; and
a merchant dashboard configured to notify a merchant of the purchase and schedule shipment of the product according to the user-selected future shipment date.

12. The downloadable e-commerce software plug-in of claim 11, wherein the scheduling module includes a calendar interface allowing the user to select one or more available shipping dates.

13. The downloadable e-commerce software plug-in of claim 11, wherein the payment processing module applies a consumer service fee at checkout separate from the merchant's product price.

14. The downloadable e-commerce software plug-in of claim 11, wherein the merchant dashboard is configured to generate notifications or reminders to customers and merchants regarding upcoming scheduled shipment dates.

15. The downloadable e-commerce software plug-in of claim 11, wherein the plug-in is configured to integrate with an existing e-commerce platform selected from the group consisting of Shopify, WooCommerce, Magento, and BigCommerce.

16. The downloadable e-commerce software plug-in of claim 11, wherein the scheduling module allows shipment to be delayed for seasonal events, holidays, or sales periods.

17. The downloadable e-commerce software plug-in of claim 11, further comprising a backend administration interface configured to allow store owners or administrators to track orders, filter by scheduled delivery date, and manage customer data associated with future shipments.

18. The downloadable e-commerce software plug-in of claim 11, wherein the system is further embodied as a mobile application (“app”) executable on iOS or Android devices, the app comprising the checkout interface, scheduling module, payment processing module, and merchant dashboard configured to perform the same functionality on a mobile device.
